(19) United States
(12) Patent Application Publication
(10) Pub. No.: US 2024/0270284 A1
(43) Pub. Date: Aug. 15, 2024

(54) SYSTEMS AND METHODS ASSOCIATED WITH RECURRENT OBJECTS

(71) Applicant: Agtonomy, South San Fransisco, CA (US)

(72) Inventors: Timothy Bucher, Geyserville, CA (US); Steven Holmes, Redwood City, CA (US); Aaron Leiba, South San Fransisco, CA (US)

(21) Appl. No.: 18/440,669

(22) Filed: Feb. 13, 2024

Related U.S. Application Data
(60) Provisional application No. 63/484,612, filed on Feb. 13, 2023.

(51) Int. Cl. B60W 60/00; G01C 21/00

(52) U.S. Cl. CPC B60W 60/00272; G01C 21/3811; G01C 21/3841; B60W 2554/80; B60W 2556/50

(57) ABSTRACT

An example method may include receiving map data about a feature of an operational environment in which an autonomous vehicle operates. The method may also include obtaining sensor data about a recurrent object in the operational environment. In addition, the method may include augmenting the map data using the sensor data to be about the feature of the operational environment and the recurrent object in the operational environment. Further, the method may include generating, based on the augmented map data, a map indicating a location of the feature of the operational environment and a location of the recurrent object in the operational environment. The method may include causing the autonomous vehicle to navigate the operational environment using the map.

### CROSS-REFERENCE TO RELATED APPLICATION

This patent application claims the benefit of and priority to U.S. Provisional App. No. 63/484,612 filed Feb. 13, 2023, titled “SYSTEMS AND METHODS ASSOCIATED WITH RECURRENT OBJECTS,” which is incorporated in the present disclosure by reference in its entirety.

### FIELD

The present disclosure is generally directed towards systems and methods associated with recurrent objects.

### BACKGROUND

Unless otherwise indicated herein, the materials described herein are not prior art to the claims in the present application and are not admitted to be prior art by inclusion in this section.

Agricultural ventures, including farming, are often associated with intensive operations. In some circumstances, the operations may be intensive due to the operations being performed over large tracts of land and/or relative to a task intensive crop. In some instances, an operator may use a vehicle such as a tractor to reduce the amount of time and/or manual labor used to perform the operations.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an embodiment, an example method may include receiving map data about a feature of an operational environment in which an autonomous vehicle operates. The method may also include obtaining sensor data about a recurrent object in the operational environment. In addition, the method may include augmenting the map data using the sensor data to be about the feature of the operational environment and the recurrent object in the operational environment. Further, the method may include generating, based on the augmented map data, a map indicating a location of the feature of the operational environment and a location of the recurrent object in the operational environment. The method may include causing the autonomous vehicle to navigate the operational environment using the map.

In another embodiment, one or more computer readable mediums may be configured to store instructions that when executed perform operations. The operations may include receiving map data about a feature of an operational environment in which an autonomous vehicle operates. The operations may also include obtaining sensor data about a recurrent object in the operational environment. In addition, the operations may include augmenting the map data using the sensor data to be about the feature of the operational environment and the recurrent object in the operational environment. Further, the operations may include generating, based on the augmented map data, a map indicating a location of the feature of the operational environment and a location of the recurrent object in the operational environment. The operations may include causing the autonomous vehicle to navigate the operational environment using the map.

These and other aspects, features and advantages may become more fully apparent from the following brief description of the drawings, the drawings, the detailed description, and appended claims.

### BRIEF DESCRIPTION OF THE DRAWINGS

Example embodiments will be described and explained with additional specificity and detail through the use of the accompanying drawings in which:

FIG. 1 illustrates a block diagram of an example environment in which an autonomous vehicle may operate;

FIG. 2A illustrates a block diagram of an example environment that includes recurrent objects;

FIG. 2B illustrates a block diagram of an example environment that includes recurrent objects;

FIG. 3 illustrates a flowchart of an example method to cause an autonomous vehicle to navigate an operational environment;

FIGS. 4-10 illustrate flowcharts of example methods; and

FIG. 11 illustrates a block diagram of an example computing system,

all arranged in accordance with at least one embodiment of the present disclosure.

### DESCRIPTION OF EMBODIMENTS

Agricultural ventures, including farming, are often time consuming and of such a large scale that a vehicle, such as a tractor, provides great benefits for accomplishing operations related thereto. The vehicle may perform the operations, such as repetitive or physically taxing operations, within an operational environment to reduce an amount of time and/or an amount of manual labor associated with the agricultural ventures. For example, the vehicle may cultivate soil, plant seeds, distribute soil amendments, maintain a crop, and/or harvest the crop to reduce the amount of time and/or the amount of manual labor used to produce the crop compared to manual operations.

The vehicle may include an autonomous vehicle that operates and/or navigates autonomously and/or semi-autonomously within the operational environment. For example, the autonomous vehicle may be configured to autonomously navigate and cultivate the soil within the operational environment. The autonomous vehicle may autonomously navigate the operational environment using map data that includes data about features of the operational environment. In some circumstances, the autonomous vehicle may not be able to obtain the map data and/or the map data may include errors such that autonomous navigation based on the map data may be unreliable.

Aspects of the present disclosure address these and other shortcomings by generating augmented map data that includes the map data or sensor data. The autonomous vehicle may obtain the map data or the sensor data. The sensor data may include data about recurrent objects, non-recurrent objects, or other aspects within the operational environment. In some embodiments, the autonomous vehicle may generate the augmented map data by augmenting the map data with the sensor data. Accordingly, the augmented map data may include data about the features of the operational environment and the objects located in the operational environment. Alternatively, the autonomous vehicle may generate the augmented map data to be representative of just the sensor data. In other words, the autonomous vehicle may generate the augmented map data based on the map data or the sensor data.

The autonomous vehicle may generate a map of the operational environment based on the augmented map data. The map may show the locations of the features of the operational environment or the locations of the objects. Alternatively, or additionally, the autonomous vehicle may autonomously navigate the operational environment using the augmented map data or the map.

In the present disclosure, the term “autonomous vehicle” may refer to a tractor and/or other vehicle that may be used in an agricultural environment. Alternatively, or additionally, the term “autonomous vehicle” may include any vehicle that operates autonomously and/or may be used in any applicable environment. While discussed primarily in relation to an agricultural environment, some embodiments of the present disclosure may be used in other environments, such as mining, construction, and/or other environments where a vehicle may be beneficial.

These and other embodiments of the present disclosure will be explained with reference to the accompanying figures. It is to be understood that the figures are diagrammatic and schematic representations of such embodiments, and are not limiting, nor are they necessarily drawn to scale. In the figures, features with like numbers indicate like structure and function unless described otherwise.

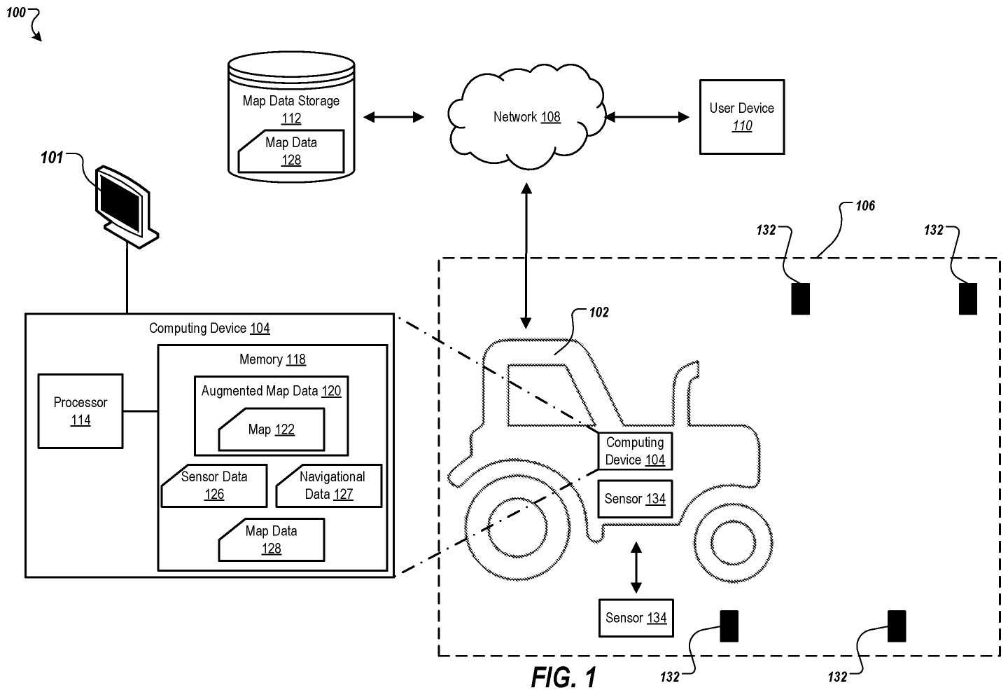

FIG. 1 illustrates a block diagram of an example environment 100 in which an autonomous vehicle 102 may operate, in accordance with at least one embodiment described in the present disclosure. The autonomous vehicle 102 may autonomously operate in an operational environment 106 that includes recurrent objects 132.

The autonomous vehicle 102 may autonomously navigate and/or operate within the operational environment 106 based on data about the operational environment 106. For example, the autonomous vehicle 102 may autonomously navigate the operational environment 106 based on map data 128 obtained from a map data storage 112. However, the map data storage 112 may not always be available, the map data 128 may be degraded due to errors during transmission, or the map data 128 may be outdated and not representative of current features of the operational environment 106. For example, the map data 128 may not be representative of the recurrent objects 132.

In some embodiments, the autonomous vehicle 102 may include a computing device 104 configured to receive and store data. For example, the computing device 104 may receive and store the map data 128 from the map data storage 112 or sensor data 126 and/or navigational data 127 (generally referred to in the present disclosure as the stored data) from one or more sensors 134. The computing device 104 may generate augmented map data 120 for autonomous navigation of the autonomous vehicle 102 based on the stored data. The computing device 104 is illustrated in FIG. 1 as being on the autonomous vehicle 102 for example purposes. Alternatively, the computing device 104 may be located remote to the autonomous vehicle 102.

In some embodiments, the sensor data 126 may include data regarding at least one of the recurrent objects 132. In these and other embodiments, navigational data 127 may include data regarding at least one navigational factor of the autonomous vehicle 102. Accordingly, the augmented map data 120 may include data regarding the features of the operational environment 106 from the map data 128, the recurrent objects 132 from the sensor data 126, or the navigational factors of the autonomous vehicle 102 from the navigational data 127. Consequently, the autonomous vehicle 102 may autonomously navigate the operational environment 106 based on the augmented map data 120 that is representative of information in the map data 128 or information that is not included in the map data 128.

The environment 100 may include a network 108 that includes any communication network configured for communication of signals between any of the components (e.g., 104, 110, or 112) of the environment 100. The network 108 may be wired or wireless. The network 108 may have numerous configurations including a star configuration, a token ring configuration, or another suitable configuration. Furthermore, the network 108 may include a local area network (LAN), a wide area network (WAN) (e.g., the Internet), and/or other interconnected data paths across which multiple devices may communicate. In some embodiments, the network 108 may include a peer-to-peer network. The network 108 may also be coupled to or include portions of a telecommunications network that may enable communication of data in a variety of different communication protocols.

In some embodiments, the network 108 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 108 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the computing device 104, the map data storage 112, or a user device 110.

The map data storage 112 may include any memory or data storage. The map data storage 112 may include network communication capabilities such that other components in the environment 100 may communicate with the map data storage 112. In some embodiments, the map data storage 112 may include computer-readable storage media for carrying or having computer-executable instructions or data structures stored thereon. The computer-readable storage media may include any available media that may be accessed by a general-purpose or special-purpose computer, such as a processor. For example, the map data storage 112 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium, which may be used to carry or store desired program code in the form of computer-executable instructions or data structures and that may be accessed by a general-purpose or special-purpose computer. Combinations of the above may be included in any of the map data storage 112.

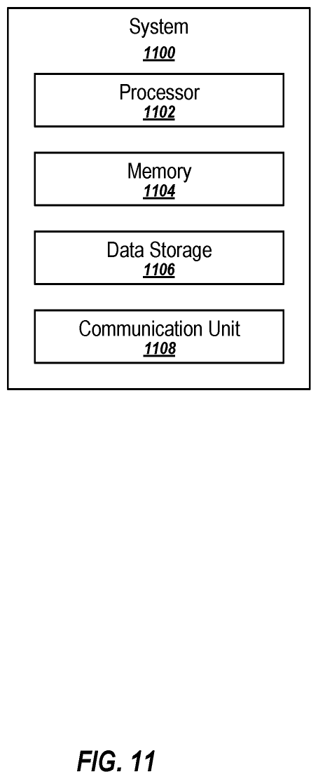

The computing device 104 may include a desktop computer, a laptop computer, a smartphone, a mobile phone, a tablet computer, a server, a processing system, or any other computing system or set of computing systems that may be used for performing the operations described in this disclosure. An example of such a computing system is described below with reference to FIG. 11. The computing device 104 may include a processor 114 and a memory 118.

The processor 114 may include a central processing unit (CPU), a microprocessor (μP), a microcontroller (μC), a digital signal processor (DSP), a field-programmable gate array (FPGA), an application-specific integrated circuit (ASIC), or any combination thereof. The processor 114 may be configured to execute computer instructions that, when executed, cause the processor 114 or the computing device 104, to perform or control performance of one or more of the operations described herein with respect to navigation or operation of the autonomous vehicle 102. The processor 114 may be implemented using a combination of hardware and software. In the present disclosure, operations described as being performed by the processor 114 or the computing device 104 may include operations that the processor 114 directs a corresponding system to perform.

The memory 118 may include a storage medium such as a RAM, persistent or non-volatile storage such as ROM, EEPROM, CD-ROM, or other optical disk storage, magnetic disk storage or other magnetic storage device, NAND flash memory or other solid state storage device, or other persistent or non-volatile computer storage medium. The memory 118 may store computer instructions that may be executed by the processor 114 or the computing device 104 to perform or control performance of one or more of the operations described herein with respect to navigation or operation of the autonomous vehicle 102. In addition, the memory 118 may store the augmented map data 120, the sensor data 126, the navigational data 127, or the map data 128, persistently and/or at least temporarily.

In some embodiments, the autonomous vehicle 102 may operate autonomously and/or semi-autonomously. In these and other embodiments, the autonomous vehicle 102 may operate with an operator present and/or with the operator located remotely. In some embodiments, the autonomous vehicle 102 may perform one or more operations based on a mission (e.g., a preplanned mission), obtained data (e.g., the stored data on the computing device 104), or operator input (e.g., teleoperations, mission updates, etc.). In some embodiments, the autonomous vehicle 102 may be configured to attach to and/or operate one or more implements.

The autonomous vehicle 102 may be the same as or similar to the tractor described in U.S. patent application Ser. No. 17/647,723 (U.S. Patent Publication No. US 2022/0219697) titled “MULTI-OPERATIONAL LAND DRONE,” which is incorporated herein in its entirety.

In some embodiments, the sensors 134 may be positioned on or in the autonomous vehicle 102 or positioned at locations within the operational environment 106. The sensors 134 external to the autonomous vehicle 102 may be communicatively coupled to the autonomous vehicle 102 to provide at least a portion of the sensor data 126 or the navigational data 127 to the autonomous vehicle 102. One sensor 134 is shown in FIG. 1 within the autonomous vehicle 102 and another sensor 134 is shown in FIG. 1 external to the autonomous vehicle 102 for example purposes. Any appropriate arrangement of the sensors 134 may be implemented.

The sensors 134 may include one or more devices configured to generate the sensor data 126, the navigational data 127, or any other appropriate data. Alternatively, or additionally, the sensors 134 may generate the sensor data 126 or the navigational data 127 to include data about factors of components used by the autonomous vehicle 102 (e.g., implements attached to and/or operated by the autonomous vehicle 102). Examples of the sensors 134 include a camera, a video camera, a Light Detection and Ranging (LiDAR) device, a radar device, an infrared device, a GPS device, other devices configured to capture images, a revolutions per minute (RPM) device, or any other appropriate sensor.

The operational environment 106 may include any location in which the autonomous vehicle 102 may operate. In addition, the operational environment 106 may include any location that includes the recurrent objects 132. For example, the operational environment 106 may include a plot of land in which one or more annual crops, or perennial crops that persist between growing seasons, such as grapes, olives, walnuts, almonds, various berry varieties, and the like are grown. Alternatively, or additionally, the operational environment 106 may include other locations such as a construction site, a mining site, and the like.

The recurrent objects 132 may be distributed in a recurring manner within the operational environment 106. In some embodiments, each of the recurrent objects 132 may include at least one common, similar, or same characteristic and/or feature. For example, the recurrent objects 132 may include a common, similar, or same color, size, shape, height, diameter, surface texture, or any other appropriate characteristic and/or feature. As another example, the recurrent objects 132 may include at least one common, similar, or same component, arrangement of components, or any other appropriate component.

In some embodiments, the recurrent objects 132 may be correlated and/or associated with a crop growing in the operational environment 106. For example, the recurrent objects 132 may include trunks associated with the crop, such as grape vine trunks, olive tree trunks, almond tree trunks, or any other appropriate crop trunk. Alternatively, or additionally, the recurrent objects 132 may include a structure and/or portions of a structure that may be associated with the crop. For example, the recurrent objects 132 may include vertical structure supports of hoop houses and/or vertical structure supports of vertical hydro farming structures.

The computing device 104 may receive the map data 128 from the map data storage 112. In some embodiments, the map data storage 112 may be unavailable and the computing device 104 may not receive the map data 128. In these embodiments, the computing device 104 may perform the operations described in the present disclosure without the map data 128 or with previous versions of the map data 128 stored in the memory 118. The map data 128 may include data about features of the operational environment 106. For example, the map data 128 may be include data about dimensions, a geographic location, slope, or any other feature of the operational environment 106.

In some embodiments, the computing device 104 may receive the sensor data 126 from the sensors 134. The sensors 134 may generate the sensor data 126 based on sensing the operational environment 106. The sensor data 126 may include data about the recurrent objects 132, non-recurrent objects in the operational environment 106, or any other feature of the operational environment 106 or the autonomous vehicle 102. The sensor data 126 may include data about a diameter, a color, a surface texture, a size, a shape, a height, a component, an arrangement of components, or any other feature of the recurrent objects 132 or other aspects of the operational environment 106. In addition, the sensor data 126 may include data about a rate of spray delivered per minute, an RPM of a mowing blade, an estimated hours until maintenance of the autonomous vehicle 102, or any other feature of the autonomous vehicle 102 or the operational environment 106. Additionally or alternatively, the sensor data 126 may include other data associated with the operational environment 106 or the recurrent objects 132.

The sensor data 126 may include data about features at different times or relative to different locations within the operational environment 106. For example, a portion of the sensor data 126 may include data relative to a first location within the operational environment 106 and another portion of the sensor data 126 may include data relative to a second location within the operational environment 106. As another example, a portion of the sensor data 126 may include data relative to a first time and another portion of the sensor data 126 may include data relative to a second time.

In some embodiments, the computing device 104 may receive the navigational data 127 from the sensors 134. The sensors 134 may generate the navigational data 127 based on sensing the autonomous vehicle 102 or the operational environment 106. The navigational data 127 may include data about a speed, a direction, a global positioning system (GPS) location, a precise GPS location, an RPM of an engine, or any other navigational factor of the autonomous vehicle 102.

The computing device 104 may augment the map data 128 using the sensor data 126 or the navigational data 127. In some embodiments, the computing device 104 may generate the augmented map data 120 by adding at least a portion of the sensor data 126 or the navigational data 127 to the map data 128. The augmented map data 120 may include data about the features in the map data 128, the features in the sensor data 126, or the navigational factors in the navigational data 127.

The computing device 104 may determine locations of the recurrent objects 132 or identify the recurrent objects 132 based on the sensor data 126. In some embodiments, the computing device 104 may determine the locations or the identities of each of the recurrent objects 132 in parallel. In other embodiments, the computing device 104 may determine the locations or the identities of the recurrent objects 132 one at a time. The augmented map data 120 may include data about the locations of the recurrent objects 132, the identities of the recurrent objects 132, or the other data.

In some embodiments, the computing device 104 may determine the locations of the recurrent objects 132 relative to the autonomous vehicle 102. For example, the sensors 134 may include the LiDAR device and the computing device 104 may determine the locations of the recurrent objects 132 relative to the autonomous vehicle 102 based on a difference in time between signals transmitted and received by the LiDAR device.

The computing device 104 may determine the locations of the recurrent objects 132 relative to the operational environment 106. For example, the computing device 104 may determine a distance between the recurrent objects 132 and the autonomous vehicle 102, determine a current location of the autonomous vehicle 102, and then determine the locations of the recurrent objects 132 relative to the operational environment 106 based on both the distance between the recurrent objects 132 and the autonomous vehicle 102 and the current location of the autonomous vehicle 102.

In some embodiments, the computing device 104 may identify the recurring objects 132 by comparing the sensor data 126 to data corresponding to known recurrent objects. For example, the sensor data 126 may include images of the recurrent objects 132 and the computing device 104 may compare the images in the sensor data 126 to images of known recurrent objects.

The computing device 104 may determine a confidence score of the locations or the identities of the recurrent objects 132. In some embodiments, the computing device 104 may determine the confidence score based on individual locations or identities of the recurrent objects 132. In other embodiments, the computing device 104 may determine the confidence score based on grouped locations or grouped identities of the recurrent objects 132. Additionally or alternatively, the computing device 104 may determine the confidence score based on the locations or the identities of the recurrent objects 132 being determined as being the same or similar over a time period or relative to different locations in the operational environment 106 (e.g., from various vantage points).

The computing device 104 may generate a map 122 based on the augmented map data 120. As shown in FIG. 1, the map 122 may be included in the augmented map data 120. Alternatively, the map 122 may be separate from the augmented map data 120. The computing device 104 may compile the individual locations of the recurrent objects 132 such that the map 122 indicates the locations of the features of the operational environment 106 from the map data 128 and the locations of the recurrent objects 132 from the sensor data 126. The map 122 may include a pre-existing map corresponding to the operational environment 106 and the computing device 104 may add the locations of the recurrent objects 132 to the pre-existing map. The map 122 may include a three-dimensional view of the recurrent objects 132 or a bird's eye view of the operational environment 106.

In some embodiments, the computing device 104 may cause the autonomous vehicle 102 to autonomously navigate the operational environment 106 using the map 122. In these and other embodiments, the computing device 104 may cause the autonomous vehicle 102 to autonomously navigate the operational environment 106 using the augmented map data 120. Accordingly, the autonomous vehicle 102 may move within the operational environment 106 to avoid the recurrent objects 132, perform operations relative to the recurrent objects 132, perform operations relative to the crop growing within the operational environment 106, or any other appropriate operation.

In some embodiments, as the autonomous vehicle 102 navigates the operational environment 106, the computing device 104 may utilize the sensor data 126 or the navigational data 127 to aid the navigation. For example, in instances in which a GPS signal becomes degraded, the computing device 104 may continue operations such as via the detection, identification, or mapping of the recurrent objects 132.

In some embodiments, the computing device 104 may display the map 122 via a display 101 for viewing and/or interaction by the operator. In these and other embodiments, the computing device 104 may display the map 122 via a display of a user device 110. The user device 110 may include any appropriate computing system and may be the same as or similar to the computing device 104 and an example of such a computing system is described below with reference to FIG. 11. In some embodiments, the computing device 104 may display other data via the display 101 or the user device 110. The interaction by the operator may include instructions for the autonomous vehicle 102 relative to the operational environment 106 or the recurrent objects 132. For example, the recurrent objects 132 may individually include an associated diameter that may be viewed when selected.

In some embodiments, the computing device 104 may generate one or more three-dimensional images to show on the display 101. The three-dimensional images may be a three-dimensional representation of the operational environment 106, the recurrent objects 132, the autonomous vehicle 102, or any other appropriate object. Portions of the sensor data 126 may be combined to generate the three-dimensional images. For example, the sensor data 126 may include a first image of an individual recurrent object 132 (e.g., first sensor data) and a second image of the individual recurrent object 132 (e.g., second sensor data) that are stitched or otherwise combined to generate the three-dimensional image. In some embodiments, the sensors 134 may generate the portions of the sensor data 126 relative to different locations within the operational environment 106, which may be combined to generate the three-dimensional image. For example, the sensor 134 may include a device positioned on a front portion of the autonomous vehicle 102, which may generate a first image and the sensor 134 may include another device positioned on a back portion of the autonomous vehicle 102, which may generate a second image. The first image and the second image may be combined to generate the three-dimensional image of an individual recurrent object 132. In some embodiments, the different portions of the sensor data 126 may be stereographically combined.

One or more of the recurrent objects 132 may be partially or fully obscured from the sensor 134 on the autonomous vehicle 102 when the autonomous vehicle 102 is at different locations or at different times. To account for the possibility of the recurrent objects 132 being obscured, the computing device 104 may compare the different portions of the sensor data 126 to determine whether individual recurrent objects 132 are detected at different times or relative to different locations. For example, the computing device 104 may compare a first image of an area that includes the individual recurrent object 132 captured at first time to a second image of the area that includes the individual recurrent object 132 captured at a second time. As another example, the computing device 104 may compare a first image of the area that includes the individual recurrent object 132 captured relative to a first location to a second image of the area that includes the individual recurrent object 132 captured relative to a second location.

In some embodiments, the computing device 104, in response to not detecting the individual recurrent object 132 at one or more times or relative to one or more different locations, may provide an alert on the display 101 or the user device 110. For example, the individual recurrent object 132 may correspond to a grape vine that may have died or been removed from the operational environment 106, the computing device 104 may detect the grape vine at a first time but may not detect the grape vine at a second time. Accordingly, the computing device 104 may provide an alert via the display 101 or the user device 110 to notify the operator that the grape vine is not detected and may need to be replaced.

In some embodiments, the autonomous vehicle 102 may predict locations of the recurrent objects 132 based on the augmented map data 120, input from the operator, or any other appropriate data. For example, the computing device 104 may detect or identify an individual recurrent object 132 and based on the detection or identity of the individual recurrent object 132 and an expected length of the operational environment 106, the computing device 104 may predict a location of another recurrent object 132. As another example, the operator input may indicate a length of a path through the operational environment 106 and the computing device 104 may predict a number or locations of the recurrent objects 132 proximate or adjacent to the path.

In some embodiments, the sensor data 126 may include data about one or more metrics associated with the recurrent objects 132 at different times. For example, the sensor data 126 may include data about a diameter, a color, a surface texture, or other feature of the recurrent objects 132. The computing device 104 may compare the metrics corresponding to different times to determine changes in the recurrent objects 132, the crop, or any other aspect. Additionally or alternatively, the computing device 104 may compare the metrics corresponding to different times to determine a health, a growth, or any other status of the crop corresponding to the recurrent objects 132.

The computing device 104 may determine one or more missions (e.g., one or more sequences of operations) relative to the recurrent objects 132 or the crop to cause a change in the health, the growth, or any other status of the crop based on the comparison of the metrics. For example, the computing device 104 may determine that the crop failed to satisfy a threshold of growth based on the sensor data 126 and may determine one or more missions (e.g., variations in the amount and/or frequency of watering, spraying, or mowing) to improve the growth of the crop. The computing device 104 may determine the missions relative to the entire crop, all of the recurrent objects 132, part of the crop, or part of the recurrent objects 132. The computing device 104 may cause the autonomous vehicle 102 to perform the mission.

The autonomous vehicle 102 may determine a path through the operational environment 106 based on the augmented map data 120, the map 122, operations associated with the mission, or the operator input. For example, the autonomous vehicle 102 may receive a mission to mow grass in the operational environment 106 and based on the mowing mission and the locations of the recurrent objects 132, the computing device 104 may determine a path through the operational environment 106 for the autonomous vehicle 102 to mow the grass and to avoid or traverse proximate the recurrent objects 132.

In some embodiments, the path may be received via the operator input (e.g., via a graphical user interface (GUI) associated with the computing device 104). For example, the map 122 of the operational environment 106 may be displayed on the display 101 and the operator may draw a path in the GUI. The operator input and associated mapping and navigation may be the same or similar as the systems and methods described in application Ser. No. 18/455,269, titled OPERATOR DIRECTED AUTONOMOUS SYSTEM, which is incorporated herein in its entirety.

The path of the autonomous vehicle 102 provided by the operator may be supplemented by the detection of the recurrent objects 132. For example, the autonomous vehicle 102 may not be able to safely traverse the operator provided path due to a proximity of the path relative to one or more of the recurrent objects 132. The operator may enter the path that the autonomous vehicle 102 cannot safely traverse due to a lack of precision in the map 122 being displayed, a lack of clarity in the display 101, operator error, or any other issue. In some embodiments, the computing device 104 may utilize the sensor data 126 to detect or identify the recurrent objects 132 to determine an alternative path that the autonomous vehicle 102 may safely traverse.

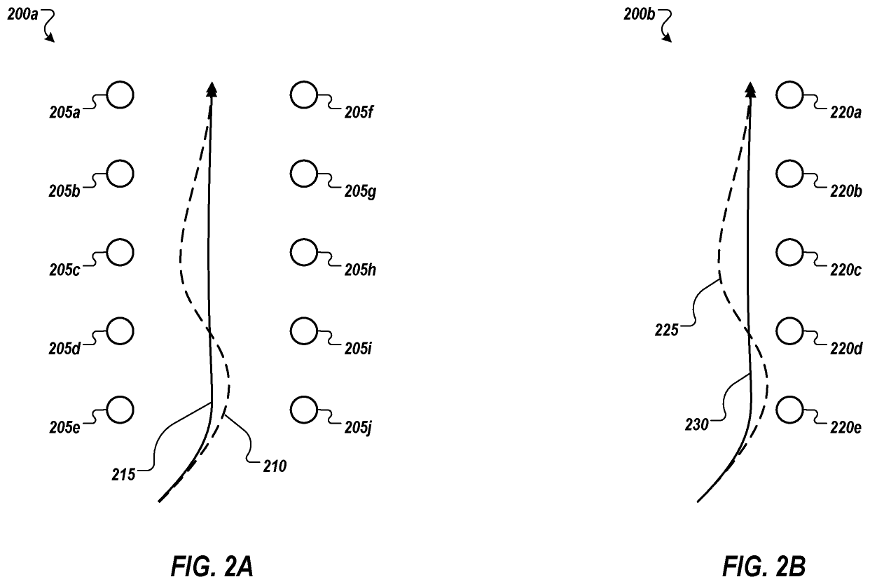

As the autonomous vehicle 102 traverses a path, the computing device 104 may determine distances between the autonomous vehicle 102 and the recurrent objects 132. For example, the computing device 104 may determine a first distance between an individual recurrent object 132 and the autonomous vehicle 102 and a second distance between another individual recurrent object 132 and the autonomous vehicle 102. The computing device 104 may adjust the path to center the autonomous vehicle 102 between the recurrent objects 132, positionally offset the autonomous vehicle 102 from the recurrent objects 132, or otherwise adjust the path relative to the recurrent objects 132, such as described below in relation to FIGS. 2A and 2B. For example, in response to the first distance differing from the second distance by a threshold distance, the computing device 104 may adjust the path of the autonomous vehicle 102 to center the autonomous vehicle 102 between the individual recurrent object 132 and the other recurrent object 132.

The computing device 104 may cause the autonomous vehicle 102 to navigate the operational environment 106 to avoid the recurrent objects 132. Additionally or alternatively, the computing device 104 may cause the autonomous vehicle 102 to navigate the operational environment 106 to avoid locations of predicted recurrent objects. Further, the computing device 104 may cause the autonomous vehicle 102 to navigate the operational environment 106 to maintain a threshold distance between the autonomous vehicle 102 and the recurrent objects 132. For example, the computing device 104 may determine a threshold distance between the autonomous vehicle 102 and the recurrent objects 132 along a path through the operational environment 106.

In some embodiments, the threshold distance may be adjustable. For example, the threshold distance may be based on the type of the recurrent object 132, a time of season, current and/or past weather conditions, among other factors. For example, when the recurrent object 132 is a grape vine but the season is when the grape vine is dormant, the threshold distance may be less than near the end of the growing season when the grape vine may have many vines that may be affected by the autonomous vehicle 102. As another example, the threshold distance may be based on the operational parameters of the autonomous vehicle 102, including speed, RPM, instruments or tools being deployed, tire size, etc. For example, in instances in which the autonomous vehicle 102 is moving at a comparatively higher rate of speed, the threshold distances may be greater than instances in which the autonomous vehicle 102 is moving at a comparatively lower rate of speed. The threshold distances and associated changes in operation may facilitate impact protection to the autonomous vehicle 102, the recurrent objects 132, or other obstacles or objects in the operational environment 106.

In some embodiments, the autonomous vehicle 102 may include multiple threshold distances (e.g., an upper threshold distance and a lower threshold distance). The autonomous vehicle 102 may be configured to perform different operations based on which of the threshold distances are satisfied. For example, the autonomous vehicle 102 may include a first threshold distance and a second threshold distance. In some embodiments, the second threshold distance may be nearer to the recurrent objects 132 than the first threshold distance.

In some embodiments, in response to a distance between the autonomous vehicle 102 and the recurrent object 132 being less than or equal to the first threshold distance but greater than the second threshold distance, the computing device 104 may provide an alert on the display 101 or the user device 110. As another example, in response to the distance being less than or equal to the second threshold distance, the computing device 104 may cause the autonomous vehicle 102 to stop navigating the operational environment 106. Additionally or alternatively, the computing device 104 may cause a change in operations of the autonomous vehicle 102 (e.g., vary from a current mission or adjust the path) in response to the distance being equal to or less than the second threshold distance.

In some embodiments, at least part of the sensor data 126, the navigational data 127, or the map data 128 may be permanently included in the augmented map data 120. Alternately or additionally, at least part of the sensor data 126, the navigational data 127, or the map data 128 may be temporarily included in the augmented map data 120. Further, the sensor data 126, the navigational data 127, or the map data 128 may be manually removed from the augmented map data 120 or removed by updating the augmented map data 120.

In some embodiments, the sensor data 126, the navigational data 127, or the map data 128 may include expiration times after which the data may be removed from the augmented map data 120. For example, the sensor data 126 may include an expiration time of five minutes, the navigational data 127 may include an expiration time of thirty seconds, and the map data 128 may include an expiration time of twenty-four hours. Alternatively, the expiration times may be based on a number of determinations made regarding the autonomous vehicle 102. For example, the sensor data 126 or the navigational data 127 may include an expiration time of a single determination of a distance between the current location of the autonomous vehicle 102 and an individual recurrent object 132.

In some embodiments, the expiration time may be based on a result of a determination satisfying a threshold requirement. For example, in response to the distance between the autonomous vehicle 102 and the individual recurrent object 132 satisfying a threshold distance or a distance between the path and the recurrent objects 132 satisfying the threshold distance, the sensor data 126 may be removed from the augmented map data 120.

The recurrent objects 132 may be associated with the crop growing in the operational environment 106 such that the computing device 104 may determine a location of at least part of the crop based on the sensor data 126. Portions of the crop may be positioned between or adjacent to at least part of the recurrent objects 132 and the computing device 104 may determine locations of the portions of the crop based, in part, on the locations of the recurrent objects 132. For example, the recurrent objects 132 may include the vertical structure supports and the crop may be distributed in a recurring manner with respect to the vertical structure supports and the computing device 104 may determine the locations of the crop based on the location of the vertical structure supports.

The computing device 104 may determine one or more instances in which to turn or change location within the operational environment 106 based on the locations of the recurrent objects 132. For example, in instances in which the computing device 104 does not detect one or more of the recurrent objects 132 over a threshold distance, a time period, or a threshold number of predicted locations of the recurrent objects 132, the computing device 104 may determine that an end of a row of the recurrent objects 132 may have been reached and that the autonomous vehicle 102 may turn to begin operations relative to a subsequent row of the recurrent objects 132. In some embodiments, the threshold distance may be based on the crop associated with the recurrent objects 132. For example, some crops may be spaced closer together or further apart, such that the recurrent objects 132 may be closer or further apart and the threshold distance or the time period may be adjusted accordingly.

Referring to FIG. 2A, an operational environment 200a may include recurrent objects 205a-j (referred to collectively as the recurrent objects 205), a path 210, or an adjusted path 215. In some embodiments, the recurrent objects 205 may be the same as or similar to the recurrent objects 132 of FIG. 1 or the operational environment 200a may be the same as or similar to the operational environment 106 of FIG. 1. Alternatively, or additionally, the recurrent objects 205 may be identified within the operational environment 200a using the sensors 134, the computing device 104, or operations as described above in relation to FIG. 1, or the methods associated therewith.

In some embodiments, the path 210 may be associated with the autonomous vehicle 102 moving through the operational environment 200a. The path 210 may be provided via operator input. For example, as the operator varies a steering mechanism, the path 210 may be determined based on the changes to the steering mechanism. Alternatively, or additionally, the path 210 may be predetermined or preplanned, such as part of a mission associated with the operational environment 200a or the operator input. In these or other embodiments, the detection or identification of the recurrent objects 205 may be used to navigate the autonomous vehicle 102 through the operational environment 200a without colliding with the recurrent objects 205 or damaging the crop. For example, the computing device 104 may detect or identify the recurrent objects 205 to adjust movement of the autonomous vehicle 102 such that the autonomous vehicle 102 or associated implements do not contact or damage the crop and to permit the operator to focus on performance of the mission.

As the autonomous vehicle 102 navigates the operational environment 200a via the path 210, the computing device 104 may obtain the sensor data 126. The computing device 104 may determine distances between the recurrent objects 205 and the autonomous vehicle 102 or the path 210 based on the sensor data 126. For example, the computing device 104 may determine a first distance between the fifth recurrent object 205e and the autonomous vehicle 102 and/or the path 210 and a second distance between the tenth recurrent object 205j and the autonomous vehicle 102 or the path 210 based on the sensor data 126. In response to a difference between the distances differing by a threshold distance, the computing device 104 may adjust the path 210 to cause the autonomous vehicle 102 to traverse the adjusted path 215. In some embodiments, the adjusted path 215 may be substantially centered between a first set of the recurrent objects 205 (e.g., the recurrent objects 205a-e) and a second set of the recurrent objects 205 (e.g., the recurrent objects 205f-j).

In some embodiments, the threshold distance may be a predetermined distance, such as included in the operator input. Alternatively, or additionally, the threshold distance may vary based on the mission being performed. For example, in instances in which the mission includes a spraying operation, the threshold distance may be a first distance and in instances in which the mission includes a mowing operation, the threshold distance may be a second distance. Alternatively, or additionally, the threshold distance may be based on an implement that is attached to the autonomous vehicle 102. For example, a first implement may be associated with a first threshold distance and a second implement may be associated with a second threshold distance.

In these or other embodiments, the operator may adjust the threshold distance based on observations in the operational environment 200a, the sensor data 126, the navigational data 127, or any other reason. For example, the operator may determine that the adjusted path 215 may be further from the recurrent objects 205 than desired and the operator may adjust the threshold distance which may cause the adjusted path 215 to be closer to the recurrent objects 205.

Referring to FIG. 2B, an operational environment 200b may include recurrent objects 220a-e (referred to collectively as the recurrent objects 220), a path 225, or an adjusted path 230. In some embodiments, the recurrent objects 220 may be the same as or similar to the recurrent objects 205 of FIG. 2A, the path 225 may be the same as or similar to the path 210 of FIG. 2A, or the adjusted path 230 may be the same as or similar to the adjusted path 215 of FIG. 2A.

The path 225 may traverse relative to a single row of the recurrent objects 220 as opposed to the multiple rows of recurrent objects 205 in FIG. 2A. As the autonomous vehicle 102 navigates the operational environment 200b via the path 225, the computing device 104 may obtain the sensor data 126. The computing device 104 may determine distances between the recurrent objects 220 and the autonomous vehicle 102 or the path 230 based on the sensor data 126. For example, the computing device 104 may determine a first distance between the first recurrent object 220a and the autonomous vehicle 102 or the path 230 and a second distance between the third recurrent object 220c and the autonomous vehicle 102 or the path 230 based on the sensor data 126. In some embodiments, in response to a difference between the distances differing by the threshold distance, the computing device 104 may adjust the path 230 to cause the autonomous vehicle 102 to traverse the adjusted path 230. In some embodiments, the adjusted path 230 may be a positional offset for the autonomous vehicle 102 relative to one or more of the recurrent objects 220. The positional offset may be a distance between the autonomous vehicle 102 and one or more of the recurrent objects 220.

The upper threshold distance or the lower threshold distance may be a predetermined distance, such as included in the operator input. Alternatively, or additionally, the upper threshold distance or the lower threshold distance may vary based on the mission being performed. For example, in instances in which the mission includes a spraying operation, the upper threshold distance or the lower threshold distance may be a first set of distances and in instances in which the mission includes a mowing operation, the upper threshold distance or the lower threshold distance may be a second set of distances. Alternatively, or additionally, the upper threshold distance or the lower threshold distance may be based on an implement that is coupled to the autonomous vehicle 102. For example, a first implement may be associated with a first upper threshold distance or a first lower threshold distance and a second implement may be associated with a second upper threshold distance or a second lower threshold distance.

In some embodiments, the computing device 104 may be unable to satisfy at least one of the upper threshold distance or the lower threshold distance, such that an adjustment to the path 225 may not satisfy at least one of the upper threshold distance or the lower threshold distance. In such instances, the computing device 104 may perform a correctional response that may be predetermined or obtained from the operator. For example, in instances in which the computing device 104 is unable to satisfy at least one of the upper threshold distance or the lower threshold distance, the computing device 104 may stop the autonomous vehicle 102 performing the mission. In another example, in instances in which the computing device 104 is unable to satisfy at least one of the upper threshold distance or the lower threshold distance, the computing device 104 may obtain operator input that may direct a response of the computing device 104 relative to the upper threshold distance or the lower threshold distance. For example, the operator may direct the computing device 104 to disregard the upper threshold distance or the lower threshold distance or discontinue performance of the mission or change one or more parameters associated with the mission (e.g., discontinue the operation for circumstances in which the upper threshold distance or the lower threshold distance are not satisfied).

In these or other embodiments, the positional offset may be implemented in scenarios in which the autonomous vehicle 102 includes a one-sided implement (e.g., a mower configured to mow along one side of the autonomous vehicle 102). Alternatively, or additionally, the positional offset may be implemented in portions of the operational environment 200b in which the autonomous vehicle 102 may have an open row on a first side and a row of recurrent objects on a second side (e.g., operations on an outer portion of a first row in the operational environment 200b).

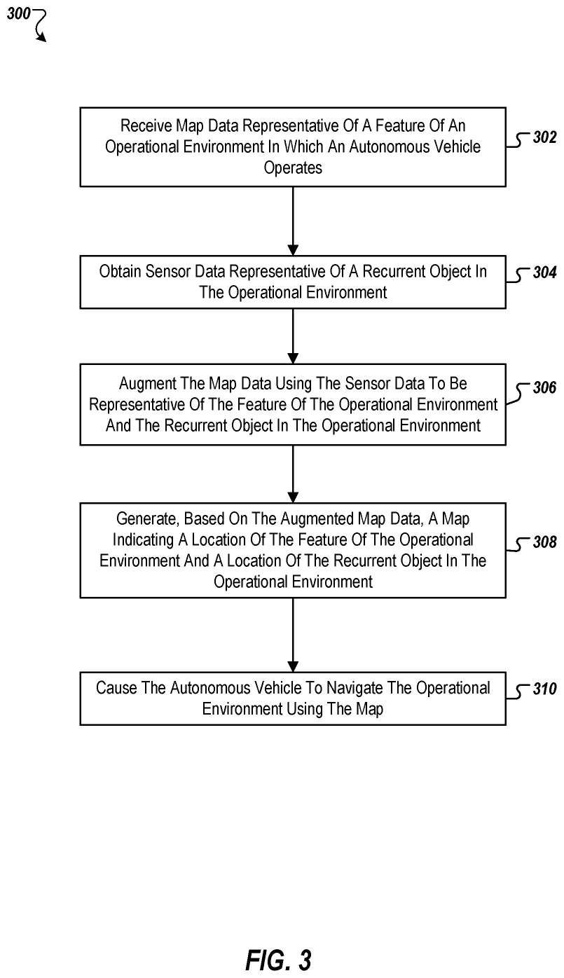

FIG. 3 illustrates a flowchart of an example method 300 to cause an autonomous vehicle to navigate an operational environment, in accordance with at least one embodiment described in the present disclosure. The method 300 may be performed by any suitable system, apparatus, or device with respect to causing the autonomous vehicle to navigate the operational environment. For example, the computing device 104, the sensors 134, the map data storage 112, or the user device 110 of FIG. 1 may perform or direct performance of one or more of the operations associated with the method 300. The method 300 may include one or more blocks 302, 304, 306, 308, or 310. Although illustrated with discrete blocks, the steps and operations associated with one or more of the blocks of the method 300 may be divided into additional blocks, combined into fewer blocks, or eliminated, depending on the particular implementation.

At block 302, map data about a feature of an operational environment in which an autonomous vehicle operates may be received. For example, computing device 104 of FIG. 1 may receive the map data 128 from the map data storage 112. At block 304, sensor data about a recurrent object in the operational environment may be obtained. For example, the computing device 104 of FIG. 1 may obtain the sensor data 126 from the sensors 134. At block 306, the map data may be augmented using the sensor data to be about the feature of the operational environment and the recurrent object in the operational environment. For example, the computing device 104 of FIG. 1 may augment the map data 128 to generate the augmented map data 120.

At block 308, a map indicating a location of the feature of the operational environment and a location of the recurrent object in the operational environment may be generated based on the augmented map data. For example, the computing device 104 of FIG. 1 may generate the map 122 to indicate the location of the features of the operational environment 106 and the locations of the recurrent objects 132 based on the augmented map data 120. At block 310, the autonomous vehicle may be caused to navigate the operational environment using the map.

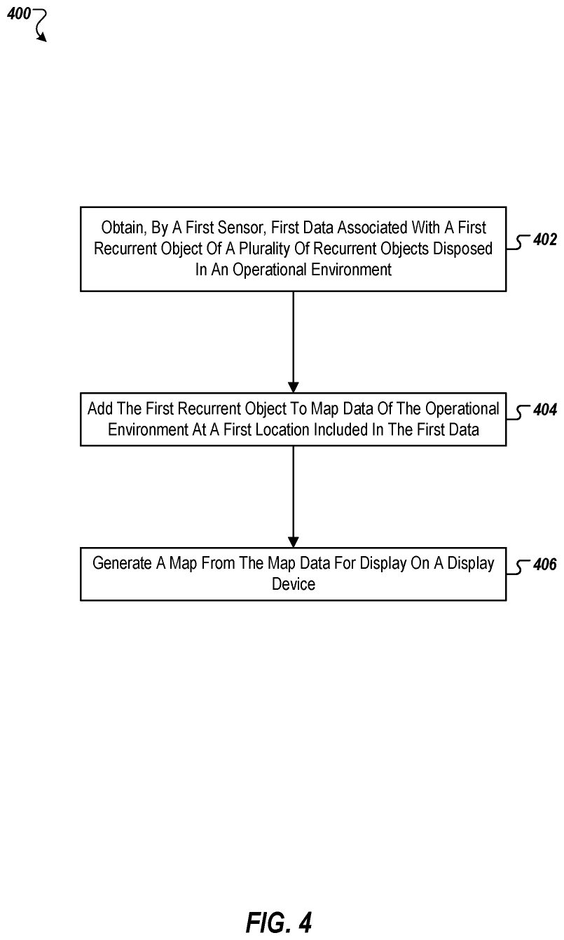

FIG. 4 illustrates a flowchart of an example method 400 to generate a map, in accordance with at least one embodiment described in the present disclosure. The method 400 may be performed by any suitable system, apparatus, or device with respect to generating the map. For example, the computing device 104, the sensors 134, the map data storage 112, or the user device 110 of FIG. 1 may perform or direct performance of one or more of the operations associated with the method 400. The method 400 may include one or more blocks 402, 404, or 406. Although illustrated with discrete blocks, the steps and operations associated with one or more of the blocks of the method 400 may be divided into additional blocks, combined into fewer blocks, or eliminated, depending on the particular implementation.

At block 402, first data associated with a first recurrent object of a plurality of recurrent objects disposed in an operational environment may be obtained by a first sensor. In some embodiments, the plurality of recurrent objects may be correlated with a crop in the operational environment. At block 404, the first recurrent object may be added to map data of the operational environment at a first location included in the first data. At block 406, a map may be generated from the map data for display on a display. In some embodiments, the map may include at least one of a three-dimensional view of the first recurrent object or a bird's eye view of the operational environment.

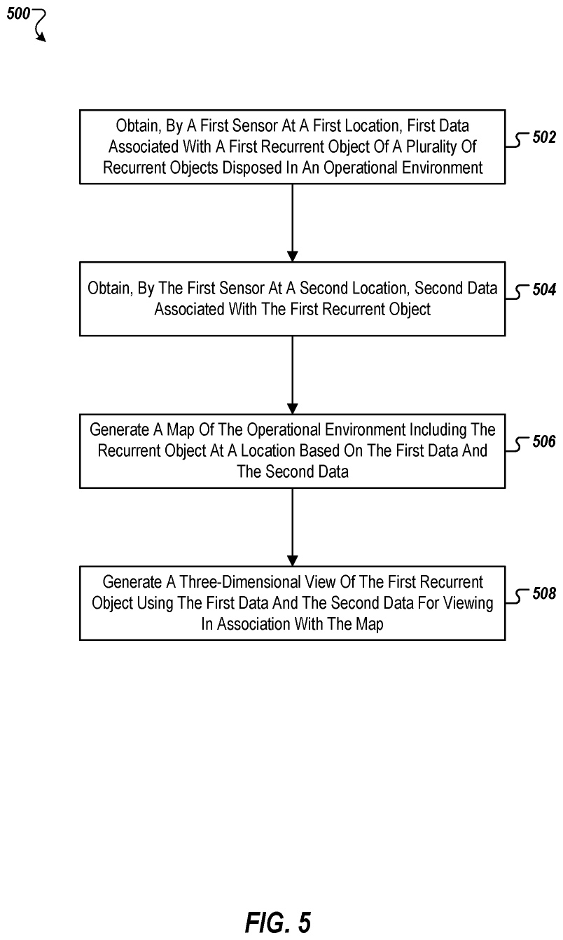

FIG. 5 illustrates a flowchart of an example method 500 to generate a three-dimensional view of a recurrent object, in accordance with at least one embodiment described in the present disclosure. The method 500 may be performed by any suitable system, apparatus, or device with respect to generating the three-dimensional view of the recurrent object. For example, the computing device 104, the sensors 134, the map data storage 112, or the user device 110 of FIG. 1 may perform or direct performance of one or more of the operations associated with the method 500. The method 500 may include one or more blocks 502, 504, 506, or 508. Although illustrated with discrete blocks, the steps and operations associated with one or more of the blocks of the method 500 may be divided into additional blocks, combined into fewer blocks, or eliminated, depending on the particular implementation.

At block 502, first data associated with a first recurrent object of a plurality of recurrent objects disposed in an operational environment may be obtained by a first sensor at a first location. In some embodiments, the plurality of recurrent objects may be correlated with a crop in the operational environment. At block 504, second data associated with the first recurrent object may be obtained by the first sensor at a second location. In some embodiments, the first recurrent object is partially obscured from the first sensor at the second location. At block 506, a map of the operational environment including the recurrent object at a location based on the first data and the second data may be generated. At block 508, a three-dimensional view of the first recurrent object using the first data and the second data for viewing in association with the map may be generated.

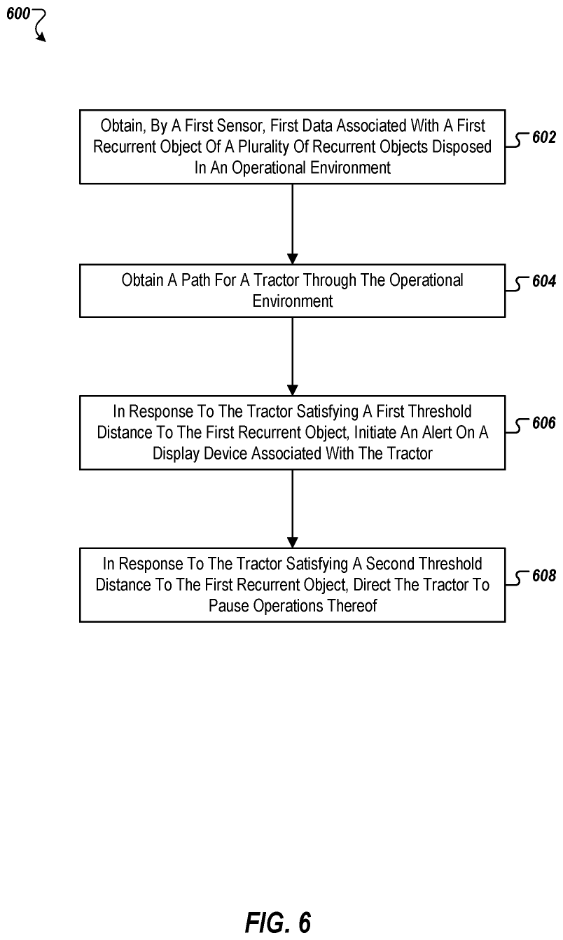

FIG. 6 illustrates a flowchart of an example method 600 to direct operation of a tractor, in accordance with at least one embodiment described in the present disclosure. The method 600 may be performed by any suitable system, apparatus, or device with respect to directing operation of the tractor. For example, the computing device 104, the sensors 134, the map data storage 112, or the user device 110 of FIG. 1 may perform or direct performance of one or more of the operations associated with the method 600. The method 600 may include one or more blocks 602, 604, 606, or 608. Although illustrated with discrete blocks, the steps and operations associated with one or more of the blocks of the method 600 may be divided into additional blocks, combined into fewer blocks, or eliminated, depending on the particular implementation.

At block 602, first data associated with a first recurrent object of a plurality of recurrent objects disposed in an operational environment may be obtained by a first sensor. In some embodiments, the plurality of recurrent objects may be correlated with a crop in the operational environment. At block 604, a path for a tractor through the operational environment may be obtained. At block 606, an alert on a display associated with the tractor may be initiated in response to the tractor satisfying a first threshold distance to the first recurrent object. At block 608, the tractor may be directed to pause operations thereof in response to the tractor satisfying a second threshold distance to the first recurrent object.

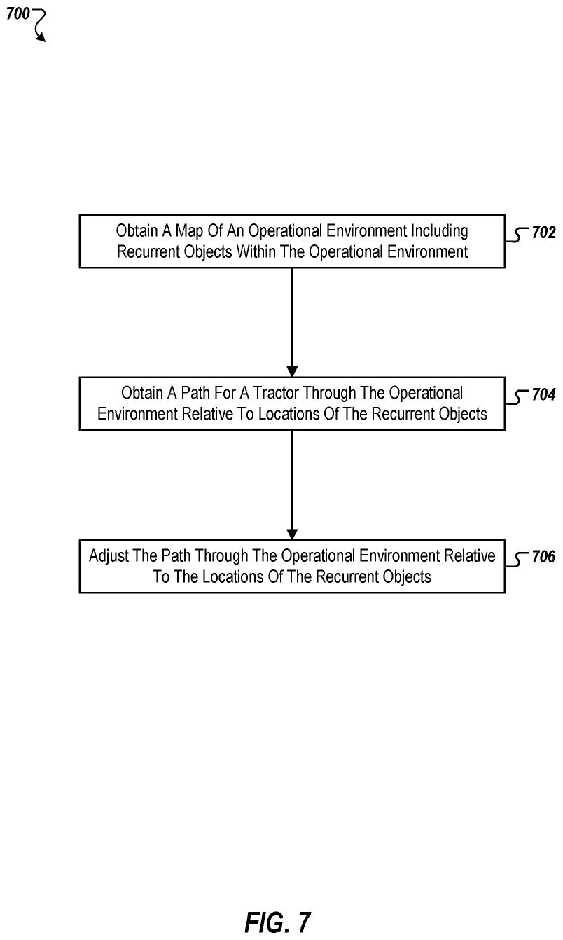

FIG. 7 illustrates a flowchart of an example method 700 to adjust a path of a tractor through an operational environment, in accordance with at least one embodiment described in the present disclosure. The method 700 may be performed by any suitable system, apparatus, or device with respect to adjusting the path of the tractor. For example, the computing device 104, the sensors 134, the map data storage 112, or the user device 110 of FIG. 1 may perform or direct performance of one or more of the operations associated with the method 700. The method 700 may include one or more blocks 702, 704, or 706. Although illustrated with discrete blocks, the steps and operations associated with one or more of the blocks of the method 700 may be divided into additional blocks, combined into fewer blocks, or eliminated, depending on the particular implementation.

At block 702, a map of an operational environment including recurrent objects within the operational environment may be obtained. In some embodiments, the recurrent objects may be correlated with a crop in the operational environment. At block 704, a path for a tractor through the operational environment relative to locations of the recurrent objects may be obtained. At block 706, the path through the operational environment may be adjusted relative to the locations of the recurrent objects. In some embodiment, the adjusting may be based at least in part on obtained data from one or more sensors associated with the tractor.

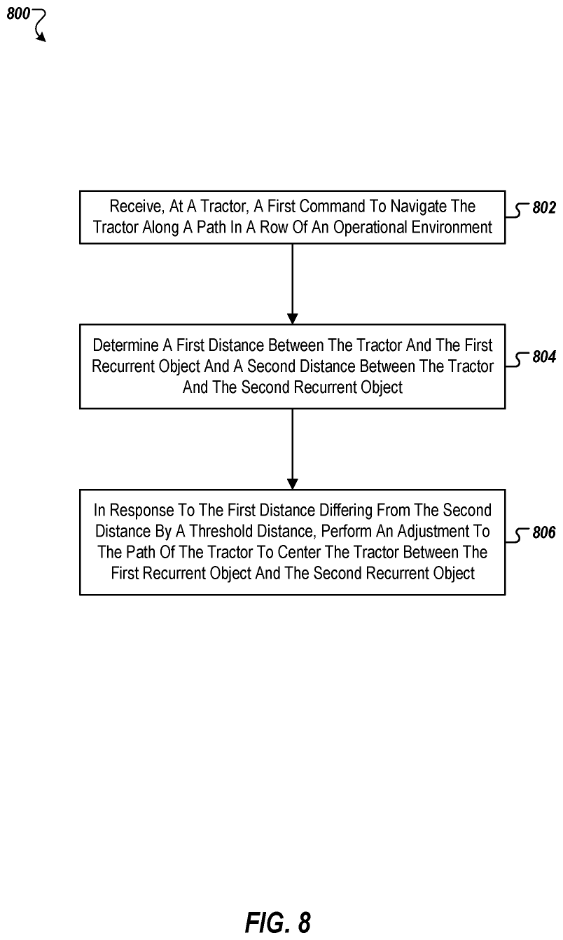

FIG. 8 illustrates a flowchart of an example method 800 to adjust a path of a tractor through an operational environment, in accordance with at least one embodiment described in the present disclosure. The method 800 may be performed by any suitable system, apparatus, or device with respect to adjusting the path of the tractor. For example, the computing device 104, the sensors 134, the map data storage 112, or the user device 110 of FIG. 1 may perform or direct performance of one or more of the operations associated with the method 800. The method 800 may include one or more blocks 802, 804, or 806. Although illustrated with discrete blocks, the steps and operations associated with one or more of the blocks of the method 800 may be divided into additional blocks, combined into fewer blocks, or eliminated, depending on the particular implementation.

At block 802, a first command to navigate the tractor along a path in a row of an operational environment may be received at a tractor. In some embodiments, the row may be disposed between a first recurrent object and a second recurrent object in the operational environment. At block 804, a first distance between the tractor and the first recurrent object and a second distance between the tractor and the second recurrent object may be determined. At block 806, an adjustment to the path of the tractor to center the tractor between the first recurrent object and the second recurrent object may be performed in response to the first distance differing from the second distance by a threshold distance.

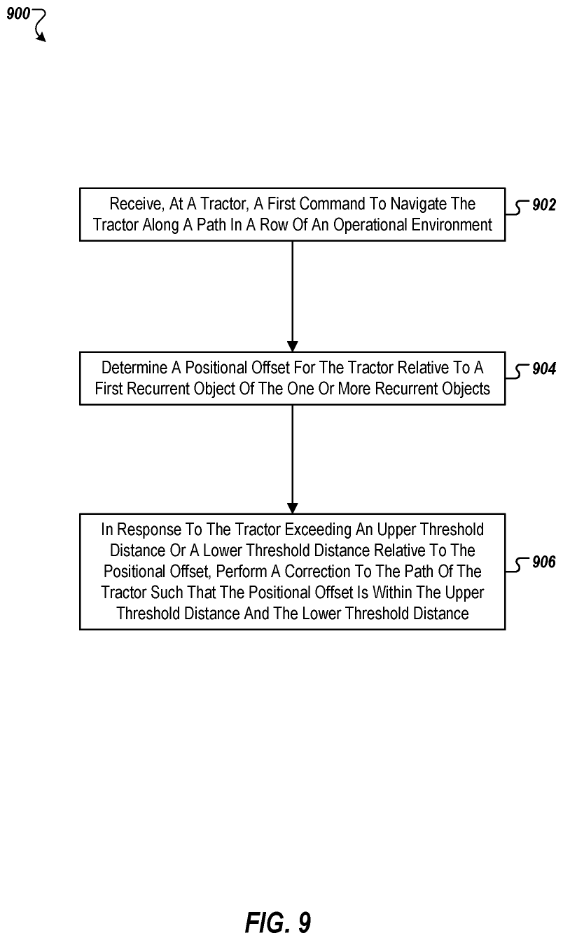

FIG. 9 illustrates a flowchart of an example method 900 to correct a path of a tractor through an operational environment, in accordance with at least one embodiment described in the present disclosure. The method 900 may be performed by any suitable system, apparatus, or device with respect to correcting the path of the tractor. For example, the computing device 104, the sensors 134, the map data storage 112, or the user device 110 of FIG. 1 may perform or direct performance of one or more of the operations associated with the method 900. The method 900 may include one or more blocks 902, 904, or 906. Although illustrated with discrete blocks, the steps and operations associated with one or more of the blocks of the method 900 may be divided into additional blocks, combined into fewer blocks, or eliminated, depending on the particular implementation.

At block 902, a first command to navigate the tractor along a path in a row of an operational environment may be received at a tractor. In some embodiments, the row may be disposed adjacent to one or more recurrent objects in the operational environment. At block 904, a positional offset for the tractor relative to a first recurrent object of the one or more recurrent objects may be determined. In some embodiments, the positional offset may include a distance from the tractor to the first recurrent object. At block 906, a correction to the path of the tractor may be performed in response to the tractor exceeding an upper threshold distance or a lower threshold distance relative to the positional offset, such that the positional offset is within the upper threshold distance and the lower threshold distance.

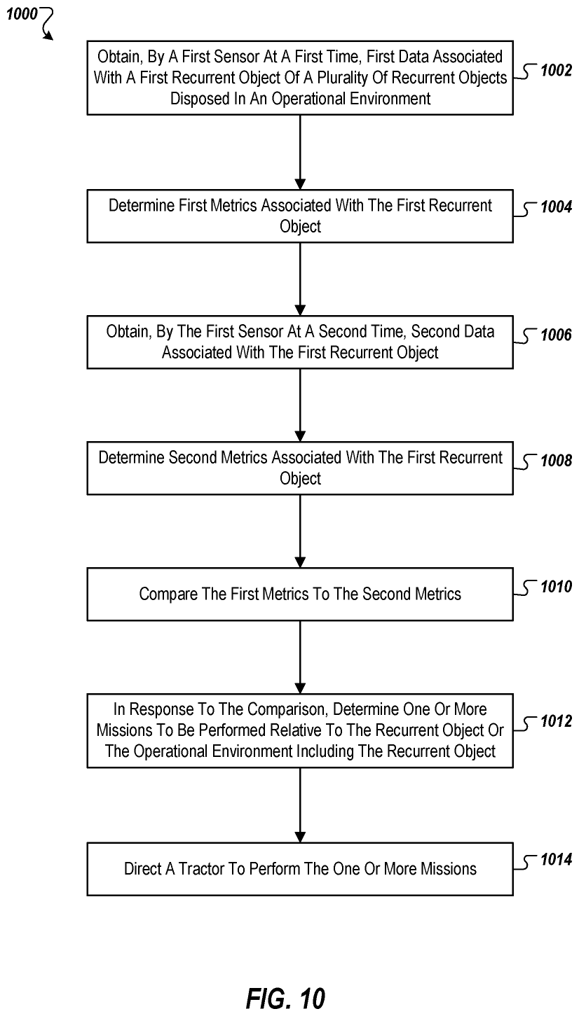

FIG. 10 illustrates a flowchart of an example method 1000 to direct a tractor to perform a mission, in accordance with at least one embodiment described in the present disclosure. The method 1000 may be performed by any suitable system, apparatus, or device with respect to directing the tractor to perform a mission For example, the computing device 104, the sensors 134, the map data storage 112, or the user device 110 of FIG. 1 may perform or direct performance of one or more of the operations associated with the method 1000. The method 1000 may include one or more blocks 1002, 1004, 1006, 1008, 1010, 1012, or 1014. Although illustrated with discrete blocks, the steps and operations associated with one or more of the blocks of the method 1000 may be divided into additional blocks, combined into fewer blocks, or eliminated, depending on the particular implementation.

At block 1002, first data associated with a first recurrent object of a plurality of recurrent objects disposed in an operational environment may be obtained by a first sensor at a first time. In some embodiments, the recurrent objects may be correlated with a crop in the operational environment. At block 1004, first metrics associated with the first recurrent object may be determined. At block 1006, second data associated with the first recurrent object may be obtained by the first sensor at a second time. At block 1008, second metrics associated with the first recurrent object may be determined. At block 1010, the first metrics may be compared to the second metrics. At block 1012, one or more missions to be performed relative to the recurrent object or the operational environment including the recurrent object may be determined in response to the comparison. At block 1014, a tractor may be directed to perform the one or more missions.

One skilled in the art will appreciate that, modifications, additions, or omissions may be made to the methods 300, 400, 500, 600, 700, 800, 900, or 1000 without departing from the scope of the present disclosure. For example, the operations of the methods 300, 400, 500, 600, 700, 800, 900, or 1000 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments. Furthermore, the outlined functions and operations are only provided as examples, and some of the functions and operations may be optional, combined into fewer functions and operations, or expanded into additional functions and operations without detracting from the essence of the disclosed embodiments.

FIG. 11 illustrates an example computing system 1100 that may be used to cause an autonomous vehicle to operate or navigate an operational environment, in accordance with at least one embodiment of the present disclosure. The computing system 1100 may be configured to implement or direct one or more operations associated with operating or navigating the autonomous vehicle in the operational environment, which may include operation of the computing device 104, the autonomous vehicle 102, the user device 110, or the map data storage 112 of FIG. 1. The computing system 1100 may include a processor 1102, a memory 1104, a data storage 1106, and a communication unit 1108, which all may be communicatively coupled. In some embodiments, the computing system 1100 may be part of any of the systems or devices described in this disclosure.

For example, the computing system 1100 may be configured to perform one or more of the tasks described above with respect to the computing device 104, the autonomous vehicle 102, the user device 110, or the map data storage 112 of FIG. 1 or any of the operations or methods associated with identifying or detecting a recurrent object and resultant operations.

The processor 1102 may include any computing entity, or processing device including various computer hardware or software modules and may be configured to execute instructions stored on any applicable computer-readable storage media. For example, the processor 1102 may include a microprocessor, a microcontroller, a parallel processor such as a graphics processing unit (GPU) or tensor processing unit (TPU), a digital signal processor (DSP), an application-specific integrated circuit (ASIC), a FPGA, or any other digital or analog circuitry configured to interpret and/or to execute program instructions and/or to process data.

Although illustrated as a single processor in FIG. 11, it is understood that the processor 1102 may include any number of processors distributed across any number of networks or physical locations that are configured to perform individually or collectively any number of operations described herein.

In some embodiments, the processor 1102 may be configured to interpret or execute program instructions or process data stored in the memory 1104, the data storage 1106, or the memory 1104 and the data storage 1106. In some embodiments, the processor 1102 may fetch program instructions from the data storage 1106 and load the program instructions in the memory 1104. After the program instructions are loaded into memory 1104, the processor 1102 may execute the program instructions.

For example, in some embodiments, the processor 1102 may be configured to interpret or execute program instructions or process data stored in the memory 1104, the data storage 1106, or the memory 1104 and the data storage 1106. The program instruction or data may be related to operating or navigating the autonomous vehicle, such that the computing system 1100 may perform or direct the performance of the operations associated therewith as directed by the instructions. In these and other embodiments, the instructions may be used to perform the methods 300, 400, 500, 600, 700, 800, 900, or 1000 of FIGS. 3-10.

The memory 1104 and the data storage 1106 may include computer-readable storage media or one or more computer-readable storage mediums for carrying or having computer-executable instructions or data structures stored thereon. Such computer-readable storage media may be any available media that may be accessed by a computer, such as the processor 1102.

By way of example, and not limitation, such computer-readable storage media may include non-transitory computer-readable storage media including RAM, ROM, EEPROM, CD-ROM, or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 1102 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 1108 may include any component, device, system, or combination thereof that is configured to transmit or receive information over a network. In some embodiments, the communication unit 1108 may communicate with other devices at other locations, the same location, or even other components within the same system. For example, the communication unit 1108 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 1108 may permit data to be exchanged with a network and/or any other devices or systems described in the present disclosure.

Modifications, additions, or omissions may be made to the computing system 1100 without departing from the scope of the present disclosure. For example, in some embodiments, the computing system 1100 may include any number of other components that may not be explicitly illustrated or described. Further, depending on certain implementations, the computing system 1100 may not include one or more of the components illustrated and described.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
receiving map data about a feature of an operational environment in which an autonomous vehicle operates;
obtaining sensor data about a recurrent object in the operational environment;
augmenting the map data using the sensor data to be about the feature of the operational environment and the recurrent object in the operational environment;
generating, based on the augmented map data, a map indicating a location of the feature of the operational environment and a location of the recurrent object in the operational environment; and
causing the autonomous vehicle to navigate the operational environment using the map.

2. The method of claim 1, wherein the map comprises at least one of a three-dimensional view of the recurrent object or a bird's eye view of the operational environment.

3. The method of claim 1 further comprising obtaining navigational data about navigational factors of the autonomous vehicle within the operational environment.

4. The method of claim 1 wherein:
the obtaining the sensor data comprises:
obtaining first sensor data about the recurrent object relative to a first location within the operational environment; and
obtaining second sensor data about the recurrent object relative to a second location within the operational environment, the recurrent object being partially obscured relative to the second location; and
the method further comprises generating a three-dimensional view of the recurrent object using the first sensor data and the second sensor data for viewing in association with the map.

5. The method of claim 1, wherein the causing the autonomous vehicle to navigate the operational environment using the map comprises:
determining a path for the autonomous vehicle through the operational environment using the map;
determining a distance between the autonomous vehicle and the recurrent object along the path;
responsive to the distance being less than or equal to a first threshold distance but greater than a second threshold distance, providing an alert on a display associated with the autonomous vehicle; and
responsive to the distance being less than or equal to the second threshold distance, causing the autonomous vehicle to stop navigating the operational environment.

6. The method of claim 1, wherein:
the obtaining the sensor data comprises:
obtaining first sensor data about the recurrent object at a first time; and
obtaining second sensor data about the recurrent object at a second time; and
the method further comprises:
comparing the first sensor data to the second sensor data;
determining whether the recurrent object is detected at the second time based on the comparison; and
responsive to the recurrent object not being detected at the second time, providing an alert on a display associated with the autonomous vehicle.

7. The method of claim 1 wherein the recurrent object comprises a first recurrent object and the causing the autonomous vehicle to navigate the operational environment using the map comprises:
determining a path for the autonomous vehicle through the operational environment using the map;
determining a first distance between the autonomous vehicle and the first recurrent object and a second distance between the autonomous vehicle and a second recurrent object within the operational environment; and
responsive to the first distance differing from the second distance by a threshold distance, adjusting the path of the autonomous vehicle to center the autonomous vehicle between the first recurrent object and the second recurrent object.

8. The method of claim 1 further comprising:
determining a first metric associated with the recurrent object at a first time;
determining a second metric associated with the recurrent object at a second time;
comparing the first metric to the second metric;
determining, based on the comparison of the first metric to the second metric, a mission to be performed relative to the recurrent object or the operational environment; and
causing the autonomous vehicle to perform the mission.

9. The method of claim 1 wherein:
the recurrent object forms part of a plurality of recurrent objects;
each of the recurrent objects of the plurality of recurrent objects comprises a common feature; and
the plurality of recurrent objects are correlated with a crop growing in the operational environment.

10. The method of claim 1, wherein the recurrent object comprises a first recurrent object and the method further comprises predicting a location of a second recurrent object within the operational environment based on the augmented map data.

11. One or more computer readable mediums configured to store instructions that when executed perform operations, the operations comprising:
receiving map data about a feature of an operational environment in which an autonomous vehicle operates;
obtaining sensor data about a recurrent object in the operational environment;
augmenting the map data using the sensor data to be about the feature of the operational environment and the recurrent object in the operational environment;
generating, based on the augmented map data, a map indicating a location of the feature of the operational environment and a location of the recurrent object in the operational environment; and
causing the autonomous vehicle to navigate the operational environment using the map.

12. The one or more computer readable mediums of claim 11, wherein the map comprises at least one of a three-dimensional view of the recurrent object or a bird's eye view of the operational environment.

13. The one or more computer readable mediums of claim 11, the operations further comprise obtaining navigational data about navigational factors of the autonomous vehicle within the operational environment.

14. The one or more computer readable mediums of claim 11 wherein:
the operation obtaining the sensor data comprises:
obtaining first sensor data about the recurrent object relative to a first location within the operational environment; and
obtaining second sensor data about the recurrent object relative to a second location within the operational environment, the recurrent object being partially obscured relative to the second location; and
the operations further comprise generating a three-dimensional view of the recurrent object using the first sensor data and the second sensor data for viewing in association with the map.

15. The one or more computer readable mediums of claim 11, wherein the operation causing the autonomous vehicle to navigate the operational environment using the map comprises:
determining a path for the autonomous vehicle through the operational environment using the map;
determining a distance between the autonomous vehicle and the recurrent object along the path;
responsive to the distance being less than or equal to a first threshold distance but greater than a second threshold distance, providing an alert on a display associated with the autonomous vehicle; and
responsive to the distance being less than or equal to the second threshold distance, causing the autonomous vehicle to stop navigating the operational environment.

16. The one or more computer readable mediums of claim 11, wherein:
the operation obtaining the sensor data comprises:
obtaining first sensor data about the recurrent object at a first time; and
obtaining second sensor data about the recurrent object at a second time; and
the operations further comprise:
comparing the first sensor data to the second sensor data;
determining whether the recurrent object is detected at the second time based on the comparison; and
responsive to the recurrent object not being detected at the second time, providing an alert on a display associated with the autonomous vehicle.

17. The one or more computer readable mediums of claim 11 wherein the recurrent object comprises a first recurrent object and the operation causing the autonomous vehicle to navigate the operational environment using the map comprises:
determining a path for the autonomous vehicle through the operational environment using the map;
determining a first distance between the autonomous vehicle and the first recurrent object and a second distance between the autonomous vehicle and a second recurrent object within the operational environment; and
responsive to the first distance differing from the second distance by a threshold distance, adjusting the path of the autonomous vehicle to center the autonomous vehicle between the first recurrent object and the second recurrent object.

18. The one or more computer readable mediums of claim 11, the operations further comprising:
determining a first metric associated with the recurrent object at a first time;
determining a second metric associated with the recurrent object at a second time;
comparing the first metric to the second metric;
determining, based on the comparison of the first metric to the second metric, a mission to be performed relative to the recurrent object or the operational environment; and
causing the autonomous vehicle to perform the mission.

19. The one or more computer readable mediums of claim 11 wherein:
the recurrent object forms part of a plurality of recurrent objects;
each of the recurrent objects of the plurality of recurrent objects comprises a common feature; and
the plurality of recurrent objects are correlated with a crop growing in the operational environment.

20. The one or more computer readable mediums of claim 11, wherein the recurrent object comprises a first recurrent object and the operations further comprise predicting a location of a second recurrent object within the operational environment based on the augmented map data.
